(19) United States
(12) Patent Application Publication
(10) Pub. No.: US 2025/0091468 A1
(43) Pub. Date: Mar. 20, 2025

(54) SYSTEMS AND METHODS FOR SEAMLESS CHECK-IN AT AN ELECTRIC VEHICLE CHARGING STATION

(71) Applicant: Volta Charging, LLC, San Francisco, CA (US)

(72) Inventor: Jeffrey KINSEY, San Francisco, CA (US)

(21) Appl. No.: 18/293,286

(22) PCT Filed: Aug. 8, 2022
(86) PCT No.: PCT/US2022/039722

§ 371 Date: Jan. 29, 2024

Related U.S. Application Data
(60) Provisional application No. 63/232,516, filed on Aug. 12, 2021.

(51) Int. Cl. B60L 53/65; H02J 7/00

(52) U.S. Cl. CPC B60L 53/65; B60L 2250/00; H02J 7/00045

(57) ABSTRACT

A server system receives, from an electric vehicle charging station, an identifier of a vehicle that has been plugged into the electric vehicle charging station (EVCS). In response to receiving the identification of the vehicle, the server system performs a lookup of the identification of the vehicle to determine that a first user is associated with the identification of the vehicle and determines whether the first user is within a predefined area relative to the EVCS. In accordance with a determination that the first user is within the predefined area relative to the EVCS, the server system transmits, to the EVCS, an instruction to initiate an operation at the EVCS.

### RELATED APPLICATIONS

This application claims priority to U.S. Provisional Application No. 63/232,516, filed Aug. 12, 2021, entitled “Systems and Methods for Seamless Check-in at an Electric Vehicle Charging Station,” which is hereby incorporated by reference in its entirety.

### TECHNICAL FIELD

This application relates generally to electric vehicle charging stations and, more particularly, to providing a seamless check-in experience for a user that has a mobile device associated with an electric vehicle.

### BACKGROUND

Electric vehicles (EVs) are growing in popularity, largely due to their reduced environmental impact and lack of reliance on fossil fuels. As the number of EVs increases, there will be a corresponding need to expand supporting infrastructure, and in particular, a need for vastly more electric vehicle charging stations (EVCS). Moreover, because EVCSs can be placed, e.g., in parking lots and on the street, the availability of electric vehicle charging stations will play an increasingly significant role in driver's decisions about where to travel.

Conventional methods and user interfaces for initiating charging of an electric vehicle require a user to manually input, on their mobile device, an identifier of the current charging station and provide approval to initiate charging, sometimes using a saved payment method. This manual intervention from a user is cumbersome.

### SUMMARY

The disclosed implementations provide systems (e.g., server systems and client devices) and methods of initiating charging a vehicle at an electric vehicle charging station (EVCS) without requiring user intervention to associate the charging process with a user's account (e.g., without requiring the user to manually check-in). Such systems and methods may also be used to initiate other operations at the EVCS, such as extending a length or amount of charging and/or increasing the power supplied to the electric vehicle.

One way to initiate charging of an EV without requiring a cumbersome manual check-in process would be for the EVCS to determine an identifier of the electric vehicle (e.g., a MAC address for the electric vehicle) and perform a look-up to determine which user is associated with the identifier of the electric vehicle. Unfortunately, merely storing a database with vehicle identifiers and payment information is not a secure method for automating the check-in process because vehicle identifiers may be spoofed by a bad actor, who would then be able to charge any vehicle.

It is thus desirable to provide a secure method for seamless check-in. Some embodiments of the present disclosure provide for secure, seamless check-in at an EVCS using dual authentication. For example, in some circumstances, the user's mobile device automatically receives an identifier of an EVCS (e.g., through a wireless beacon signal) and communicates the received EVCS identifier to a server system associated with the EVCS. The EVCS, on the other hand, receives an identifier of an electric vehicle and communicates the identifier of the EV to the server system. The server system can determine whether the user, and the user's electric vehicle, are at the same EVCS. When the user and the user's electric vehicle are at the same EVCS, as determined in this manner, an EVCS operation is automatically initiated (without user intervention); otherwise, the operation is not automatically initiated (e.g., a manual process is required to initiate the operation).

In other embodiments, biometric identification is used as the second form of authentication. For example, in some embodiments, an EVCS receives a vehicle ID when the vehicle is plugged into the EVCS. The vehicle ID is matched to a user, and sensor data from the EVCS is used to determine if that user is proximal to the EVCS using a biometric profile of the user. Upon a determination that the correct user is proximal to the EVCS, the EVCS permits charging (or allows some other operation to proceed).

In other embodiments, location data from a mobile device of the user is used as the second form of authentication. For example, in some embodiments, an EVCS receives a vehicle ID when the vehicle is plugged into the EVCS. The vehicle ID is matched to a user, and a location of the user's mobile device is determined (e.g., a GNSS location of the mobile device). The location is compared to a known location of the EVCS. Upon a determination that the correct user is proximal to the EVCS, based on the location comparison, the EVCS permits charging (or allows some other operation to proceed).

Some implementations of the present disclosure provide a computer system (e.g., a server system), comprising one or more processors and memory storing one or more programs. The one or more programs store instructions that, when executed by the one or more processors, cause the computer system to perform any of the methods described herein.

Some implementations of the present disclosure provide a computer program product (e.g., a non-transitory computer readable storage medium storing instructions) that, when executed by a computer system having one or more processors, cause the computer system to perform any of the methods described herein.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 illustrates a system for charging an electric vehicle in accordance with some implementations.

FIGS. 2A-2C illustrate a charging station for an electric vehicle in accordance with some implementations.

FIG. 3 is a block diagram of a server system in accordance with some implementations.

FIG. 4 is a block diagram of a charging station for an electric vehicle in accordance with some implementations.

FIG. 5 is a block diagram of a user device in accordance with some implementations.

FIG. 6A is a block diagram illustrating an example of seamless check-in using a beacon, in accordance with some implementations.

FIG. 6B is a block diagram illustrating an example of seamless check-in using sensor data, in accordance with some implementations.

FIG. 7A illustrates a flowchart of a method of seamless check-in using a beacon, in accordance with some implementations.

FIG. 7B illustrates a flowchart of a method of seamless check-in using sensor data, in accordance with some implementations.

FIG. 8 is a block diagram illustrating an example of seamless check-in based on a location of a mobile device, in accordance with some implementations.

FIG. 9 illustrates a flowchart of a method of seamless check-in based on a location of a mobile device, in accordance with some implementations.

FIGS. 10A-10B illustrate a flowchart of a method for seamless check-in for a user at an electric vehicle charging station (EVCS), in accordance with some implementations.

FIG. 11 illustrates a flowchart of a method for seamless check-in for a user at an EVCS, in accordance with some implementations.

FIGS. 12A-12B illustrate a flowchart of a method for seamless check-in for a user at an EVCS, in accordance with some implementations.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

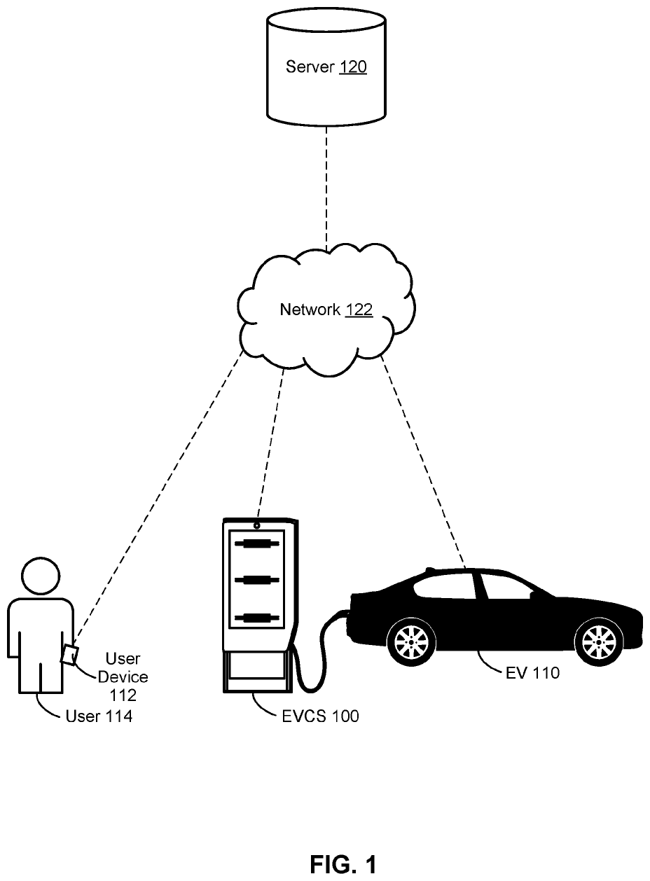

FIG. 1 illustrates an electric vehicle charging station (EVCS) 100 that is configured to provide an electric charge to an electric vehicle 110 via one or more electrical connections. In some implementations, the EVCS 100 provides an electric charge to electric vehicle 110 via a wired connection, such as a charging cable. Alternatively, the EVCS 100 may provide an electric charge to electric vehicle 110 via a wireless connection (e.g., wireless charging). In some implementations, the EVCS 100 may be in communication with the electric vehicle 110 or a user device 112 belonging to a user 114 (e.g., a driver, passenger, owner, renter, or other operator of the electric vehicle 110) that is associated with the electric vehicle 110. In some implementations, the EVCS 100 communicates with one or more devices or computer systems, such as user device 112 or server system 120, respectively, via a network 122.

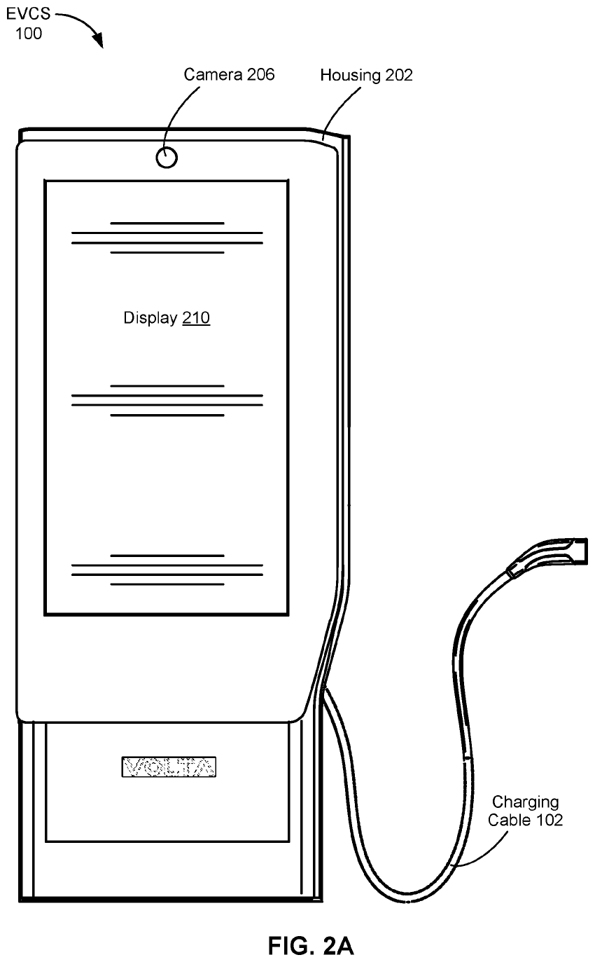

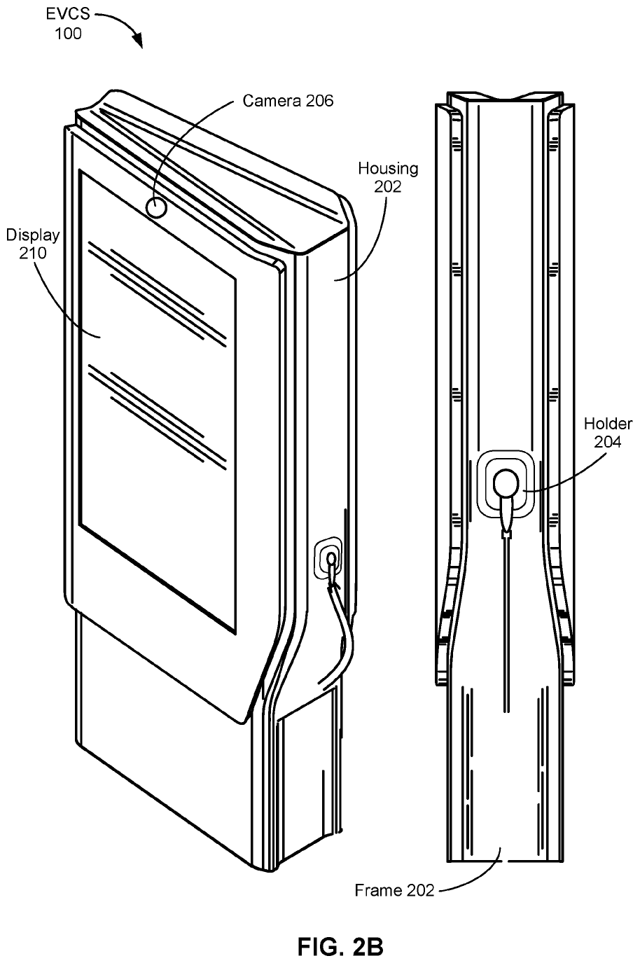

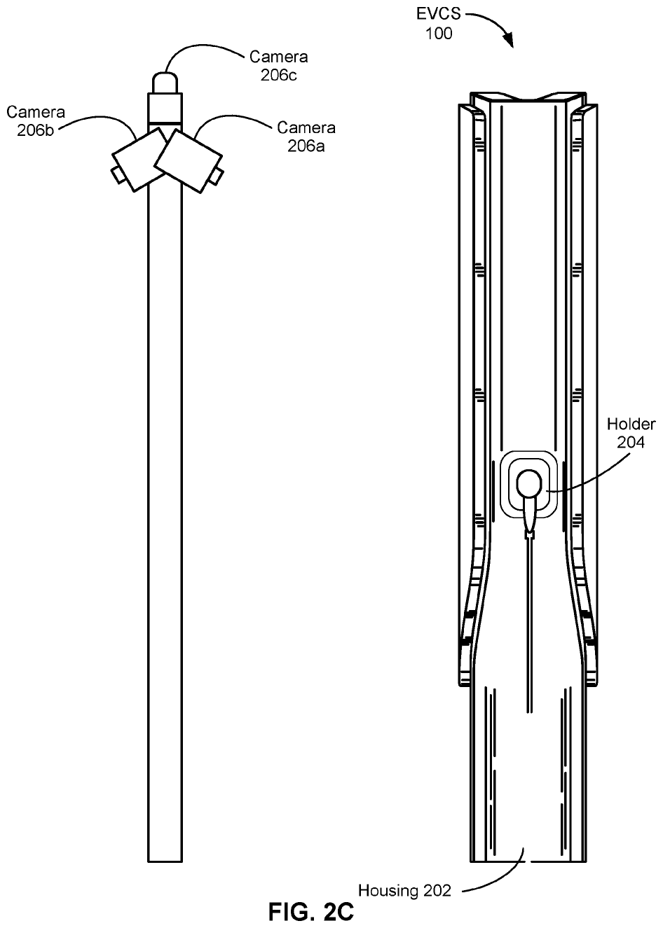

FIG. 2A is a mechanical drawing showing various views of an electric vehicle charging station (EVCS) 100, in accordance with some implementations. FIG. 2B is a mechanical drawing showing additional views of the EVCS 100 of FIG. 2A, in accordance with some implementations. FIG. 2C shows an alternative configuration of EVCS 100, in accordance with some implementations. FIGS. 2A-2C are discussed together below.

EVCS 100 includes a housing 202 (e.g., a body or a chassis) including a charging cable 102 (e.g., connector) configured to connect and provide a charge to an electric vehicle 110 (FIG. 1). An example of a suitable connector is an IEC 62196 type-2 connector or a CCS (“Combined Charging System”) standard connector (e.g., CCS1, CCS2). In some implementations, the connector is a “gun-type” connector (e.g., a charge gun) that, when not in use, sits in a holder 204 (e.g., a holster). In some implementations, the housing 202 houses circuitry for charging an electric vehicle 110. For example, in some implementations, the housing 202 includes power supply circuitry as well as circuitry for determining a state of a vehicle being charged (e.g., whether the vehicle is connected via the connector, whether the vehicle is charging, whether the vehicle is done charging, etc.).

The EVCS 100 further includes one or more displays 210 facing outwardly from a surface of the EVCS 100. For example, the EVCS 100 may include two displays 210, one on each side of the EVCS 100, each display 210 facing outwardly from the EVCS 100. In some implementations, the one or more displays 210 display messages (e.g., media content) to users of the charging station (e.g., operators of the electric vehicle) and/or to passersby that are in proximity to the EVCS 100. In some implementations, each of the displays 210 are on a respective panel that has a height that is at least 60% of a height of the housing 202 and a width that is at least 90% of a width of the housing 202. In some implementations, the panel 102 has a height that is at least 3 feet and a width that is at least 2 feet.

In some implementations, the EVCS 100 includes one or more panels that hold a display 210. The displays are large compared to the housing 202 (e.g., 60% or more of the height of the frame and 80% or more of the width of the frame), allowing the displays 210 to function as billboards, capable of conveying information to passersby. In some implementations, the displays 210 are incorporated into articulating panels that articulate away from the housing 202 (e.g., a sub-frame). The articulating panels solve the technical problem of the need for maintenance of the displays 210 (as well as one or more computers that control content displayed on the display). To that end, the articulating panels provide easy access to the entire back of the displays 210. In addition, in some implementations, the remaining space between the articulating panels (e.g., within the housing 202) is hollow, allowing for ample airflow and cooling of the displays 210.

The EVCS 100 further includes a computer that includes one or more processors and memory. The memory stores instructions for displaying content on the display 210. In some implementations, the computer is disposed inside the housing 202. In some implementations, the computer is mounted on a panel that connects (e.g., mounts) a first display (e.g., a display 210) to the housing 202. In some implementations, the computer includes a near-field communication (NFC) system that is configured to interact with a user's device (e.g., user device 112 of a user 114 of the EVCS 100).

In some implementations, the EVCS 100 includes one or more sensors (not shown) for detecting whether external objects are within a predefined region (area) proximal to the housing. For example, the area proximal to the EVCS 100 includes one or more parking spaces, where an electric vehicle 110 parks in order to use the EVCS 100. In some implementations, the area proximal to the EVCS 100 includes walking paths (e.g., sidewalks) next to the EVCS 100. In some implementations, the one or more sensors are configured to determine a state of the area proximal to the EVCS 100 (e.g., wherein determining the state includes detecting external objects). The external objects can be living or nonliving, such as people, kids, animals, vehicles, shopping carts, (kids) toys, etc. The one or more sensors can detect stationary or moving external objects. The one or more sensors of the EVCS 100 include one or more image (e.g., optical) sensors (e.g., one or more cameras 206), ultrasound sensors, depth sensors, infrared (IR), red-green-blue (RGB) cameras, passive infrared (PIR), heat IR, proximity sensors, radar, and/or tension sensors. The one or more sensors may be connected to the EVCS 100 or a computer system associated with the EVCS 100 via wired or wireless connections such as via a Wi-Fi connection or Bluetooth connection.

In some implementations, the housing 202 includes one or more lights configured to provide predetermined illumination patterns indicating a status of the EVCS 100. In some implementations, at least one of the one or more lights is configured to illuminate an area proximal to the EVCS 100 as a person approaches the area (e.g., a driver returning to a vehicle or a passenger exiting a vehicle that is parked in a parking spot associated with the EVCS 100).

In some implementations, the housing 202 includes one or more cameras 206 configured to capture one or more images of an area proximal to the EVCS 100. In some implementations, the one or more cameras 206 are configured to obtain video of an area proximal to the EVCS 100. For example, a camera may be configured to obtain a video or capture images of an area corresponding to a parking spot associated with the EVCS 100. In another example, another camera may be configured to obtain a video or capture images of an area corresponding to a parking spot next to the parking spot of the EVCS 100. In a third example, the camera 206 may be a wide angle camera or a 360° camera that is configured to obtain a video or capture images of a large area proximal to the EVCS 100, including a parking spot of the EVCS 100. As shown in FIG. 2B, the one or more cameras 206 may be mounted directly on a housing 202 of the EVCS 100 and may have a physical (e.g., electrical, wired) connection to the EVCS 100 or a computer system associated with the EVCS 100. Alternatively, as shown in FIG. 2C, the one or more cameras 206 (or other sensors) may be disposed separately from but proximal to the housing 202 of the EVCS 100. In some implementations, the camera 206 may be positioned at different locations on the EVCS 100 than what is shown in the figures. Further, in some implementations, the one or more cameras 206 include a plurality of cameras positioned at different locations on the EVCS 100.

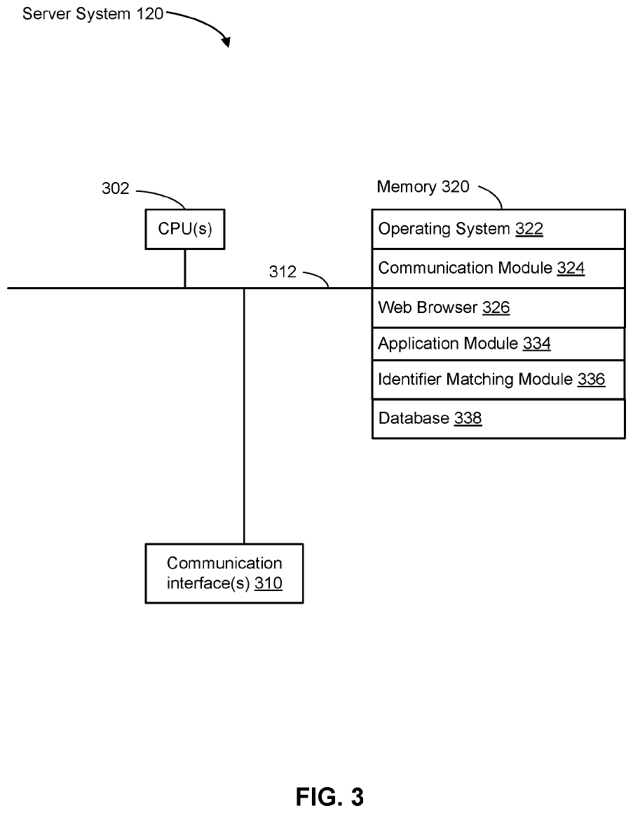

FIG. 3 is a block diagram of a server system 120, in accordance with some implementations. Server system 120 may include one or more computer systems (e.g., computing devices), such as a desktop computer, a laptop computer, and a tablet computer. In some implementations, the server system 120 is a data server that hosts one or more databases (e.g., databases of images or videos), models, or modules or may provide various executable applications or modules. The server system 120 includes one or more processing units (processors or cores, CPU(s)) 302, one or more network or other communications network interfaces 310, memory 320, and one or more communication buses 312 for interconnecting these components. The communication buses 312 optionally include circuitry (sometimes called a chipset) that interconnects and controls communications between system components.

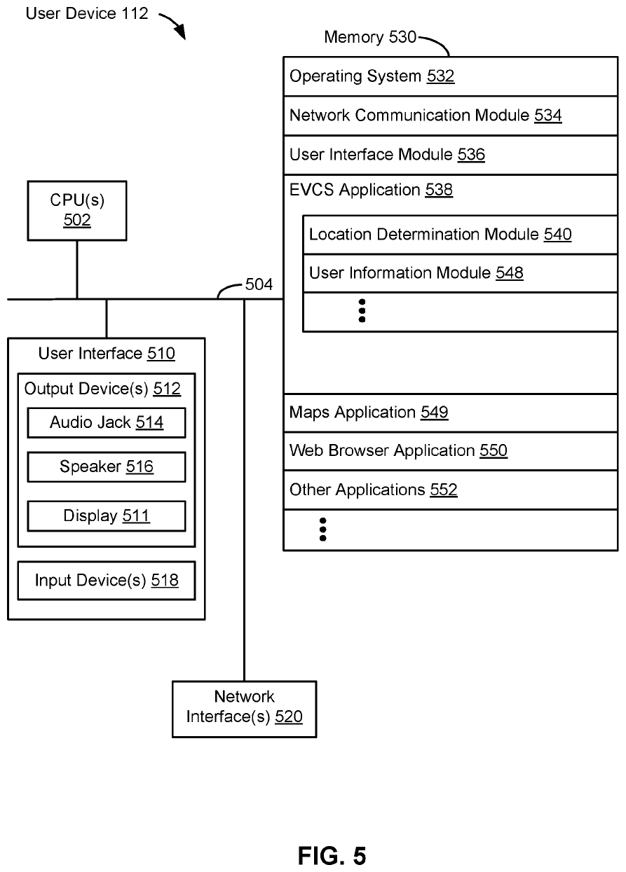

The memory 320 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 320 includes one or more storage devices remotely located from the one or more processing units 302. The memory 320, or alternatively the non-volatile memory devices within the memory 320, includes a non-transitory computer-readable storage medium. In some implementations, the memory 320 or the computer-readable storage medium of the memory 320 stores the following programs, modules, and data structures, or a subset or superset thereof:
an operating system 322, which includes procedures for handling various basic system services and for performing hardware dependent tasks;
a communications module 324, which is used for connecting the server system 120 to other computers and devices via the one or more communication network interfaces 310 (wired or wireless), such as the internet, other wide area networks, local area networks, metropolitan area networks, and so on;
a web browser 326 (or other application capable of displaying web pages), which enables a user to communicate over a network with remote computers or devices;
an application module 334 for providing services to EVCS mobile application 538 (FIG. 5), including responding to requests for available charging stations, identifying (e.g., in database 338) retail outlets that are co-located with electric vehicle charging stations, transmitting instructions to EVCS mobile application 538 to display indications of available charging stations, together with representations of the co-located retail outlets, and so forth;
an identifier matching module 336 for determining (e.g., by performing a lookup based on identifiers stored in database 338) whether a first identifier (e.g., a mobile device and/or user identifier) matches a second identifier (e.g., a vehicle identifier) to determine whether charging (or some other operation) should be initiated for a respective vehicle that has plugged into at a respective electric vehicle charging station; and
database 338 for storing information on electric vehicle charging stations, electric vehicles that have registered to charge at the electric vehicle charging stations, and mobile device identifiers for users that have opted into seamless check-in, and so forth.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 320 stores a subset of the modules and data structures identified above. Furthermore, the memory 320 may store additional modules or data structures not described above.

Although FIG. 3 shows a server system 120, FIG. 3 is intended more as a functional description of the various features that may be present rather than as a structural schematic of the implementations described herein. In practice, and as recognized by those of ordinary skill in the art, items shown separately could be combined and some items could be separated.

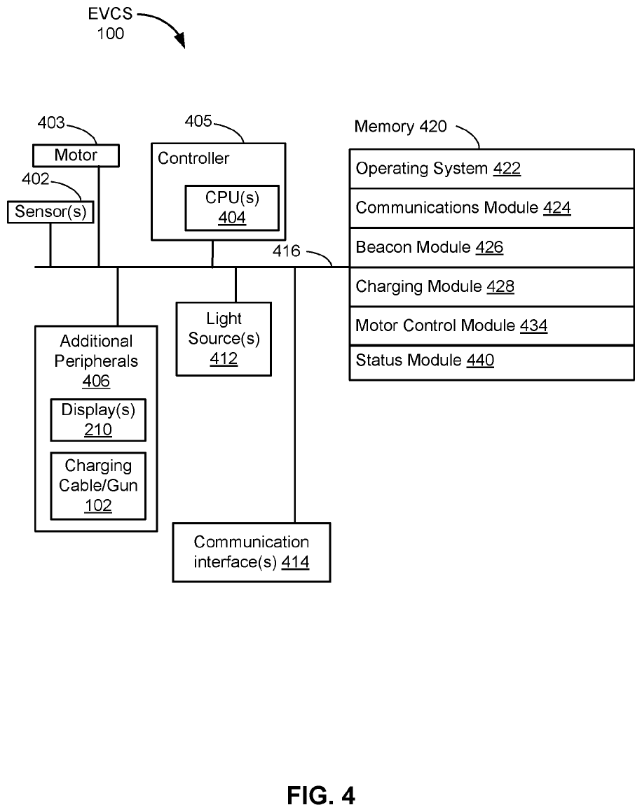

FIG. 4 is a block diagram of an EVCS 100 (FIGS. 1 and 2A-2C) for charging an electric vehicle, in accordance with some implementations. The EVCS 100 optionally includes a motor 403 (configured to retract a portion of a charging cable), a controller 405 that includes one or more processing units (processors or cores) 404, one or more network or other communications network interfaces 414, memory 420, one or more light sources 412, one or more sensors 402, additional peripherals 406, and one or more communication buses 416 for interconnecting these components. The communication buses 416 optionally include circuitry (sometimes called a chipset) that interconnects and controls communications between system components. In some implementations, the memory 420 stores instructions for performing (by the one or more processing units 404) a set of operations, including determining a status of the EVCS 100, wherein the status indicates a state of an electric vehicle 110 at the charging station.

EVCS 100 typically includes additional peripherals 406 such as displays 210 for displaying content, and charging cable 102. In some implementations, the displays 210 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

The user interface may also include one or more sensors 402 such as cameras (e.g., camera 206, described above with respect to FIGS. 2A-2B), ultrasound sensors, depth sensors, infrared cameras, visible (e.g., RGB or black and white) cameras, passive infrared sensors, heat detectors, infrared sensors, proximity sensors, or radar. In some implementations, the one or more sensors 402 are for detecting whether external objects are within a predefined region proximal to the housing, such as living and nonliving objects, and/or the status of the EVCS 100 (e.g., available, occupied, etc.) in order to perform an operation, such as retracting the charging cable safely and carefully.

The memory 420 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 420 includes one or more storage devices remotely located from the processing units 404, such as database 338 of server system 120 that is in communication with the EVCS 100. The memory 420, or alternatively the non-volatile memory devices within the memory 420, includes a non-transitory computer-readable storage medium. In some implementations, the memory 420 or the computer-readable storage medium of the memory 420 stores the following programs, modules, and data structures, or a subset or superset thereof:
an operating system 422, which includes procedures for handling various basic system services and for performing hardware dependent tasks;
a communications module 424, which is used for connecting the EVCS 100 to other computers and devices via the one or more communication network interfaces 414 (wired or wireless), such as the internet, other wide area networks, local area networks, metropolitan area networks, and so on;
a beacon module 426 for transmitting a beacon signal that includes an identifier of the EVCS 100;
a charging module 428 for charging an electric vehicle (e.g., measuring how much charge has been delivered to an electric vehicle, commencing charging, ceasing charging, etc.);
motor control module 434 that includes one or more instructions for energizing or forgoing energizing the motor; and
a status module 440 for monitoring a charging status of the EVCS 100 (e.g., a status of the EVCS 100 with respect to charging of an electric vehicle or its ability/inability to charge an electric vehicle).

In some implementations, the memory 420 stores metrics, thresholds, and other criteria, which are compared against the measurements captured by the one or more sensors 402. For example, data obtained from a PIR sensor of the one or more sensors 402 can be compared with baseline data to detect that an object is in proximity the EVCS 100.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 420 stores a subset of the modules and data structures identified above. Furthermore, the memory 420 may store additional modules or data structures not described above.

Although FIG. 4 shows an EVCS 100, FIG. 4 is intended more as a functional description of the various features that may be present rather than as a structural schematic of the implementations described herein. In practice, and as recognized by those of ordinary skill in the art, items shown separately could be combined and some items could be separated.

FIG. 5 is a block diagram of a user device 112 of a user 114 in accordance with some implementations. In some implementations, the user 114 is associated with (e.g., an operator of) an electric vehicle 110 at EVCS 100. Various examples of the computing device 112 include a cellular-capable smart device such as a smartphone, a smart watch, a laptop computer, a tablet computer, and other computing devices that have a processor capable of connecting to the EVCS 100 via a communications network (e.g., network 122), or receiving a beacon signal from an EVCS 100.

The user device 112 typically includes one or more processing units (processors or cores) 502, one or more network or other communications network interfaces 520, memory 530, and one or more communication buses 504 for interconnecting these components. The communication buses 504 optionally include circuitry (sometimes called a chipset) that interconnects and controls communications between system components. The user device 112 typically includes a user interface 510. The user interface 510 typically includes one or more output devices 512 such as an audio output device 514, such as speakers 516 or an audio output connection (e.g., audio jack) for connecting to speakers, earphones, or headphones. The user interface 510 also typically includes a display 511 (e.g., a screen or monitor). In some implementations, the user device 112 includes input devices 518 such as a keyboard, mouse, and/or other input buttons. Alternatively or in addition, in some implementations, the user device 112 includes a touch-sensitive surface. In some embodiments, the touch-sensitive surface is combined with the display 511, in which case the display 511 is a touch-sensitive display. In some implementations, the touch-sensitive surface is configured to detect various swipe gestures (e.g., continuous gestures in vertical and/or horizontal directions) and/or other gestures (e.g., single/double tap). In computing devices that have a touch-sensitive surface (e.g., a touch-sensitive display), a physical keyboard is optional (e.g., a soft keyboard may be displayed when keyboard entry is needed). Furthermore, user device 112 may also include a microphone and voice recognition software to supplement or replace the keyboard.

The memory 530 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 530 includes one or more storage devices remotely located from the processing units 502. The memory 530, or alternatively the non-volatile memory devices within the memory 530, includes a non-transitory computer-readable storage medium. In some implementations, the memory 530 or the computer-readable storage medium of the memory 530 stores the following programs, modules, and data structures, or a subset or superset thereof:
an operating system 532, which includes procedures for handling various basic system services and for performing hardware dependent tasks;
a network communication module 534, which is used for connecting the user device 112 to other computers and devices via the one or more communication network interfaces 520 (wired or wireless), such as the internet, other wide area networks, local area networks, metropolitan area networks, and so on;
a user interface module 536 for providing user interfaces for the user to interact with the user device 112 via applications on the user device 112 and the operating system 532 of the user device 112;
an EVCS mobile application 538 for communicating with an EVCS 100 or a server system that supports the EVCS 100. In some embodiments, EVCS mobile application 538 is capable of determining a current location of the user device 112 (using a location determination module 540). In some embodiments, location determination module 540 uses a global navigation satellite system (GNSS) such as the global positioning system (GPS), Galileo, BeiDou, or GLONASS;
user information module 548 for transmitting a user identifier associated with user device 112 to server system 120;
a maps application 549 for determining a location of the user device 112, including determining a proximity of the user device 112 with electric vehicle charging stations;
a web browser application 550 for accessing the internet and accessing websites on the internet, including providing functionalities on the EVCS mobile application 538 via a website accessed through web browser application 550; and
other applications 552 that the user 114 may have installed on the user device 112 or that may have been included as default applications on the user device 112.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 530 stores a subset of the modules and data structures identified above. Furthermore, the memory 530 may store additional modules or data structures not described above.

Although FIG. 5 shows a user device 112, FIG. 5 is intended more as a functional description of the various features that may be present rather than as a structural schematic of the implementations described herein. In practice, and as recognized by those of ordinary skill in the art, items shown separately could be combined and some items could be separated.

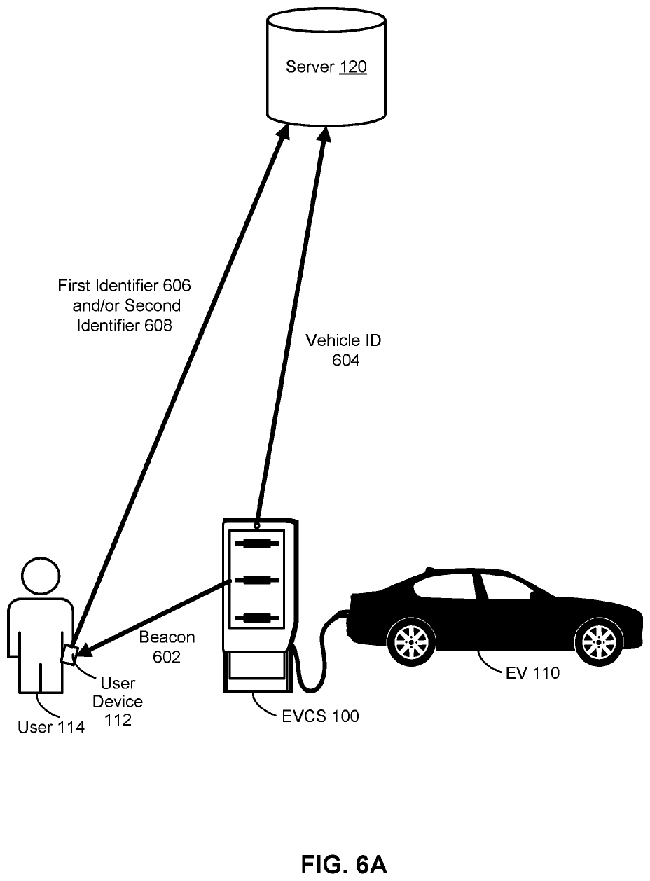

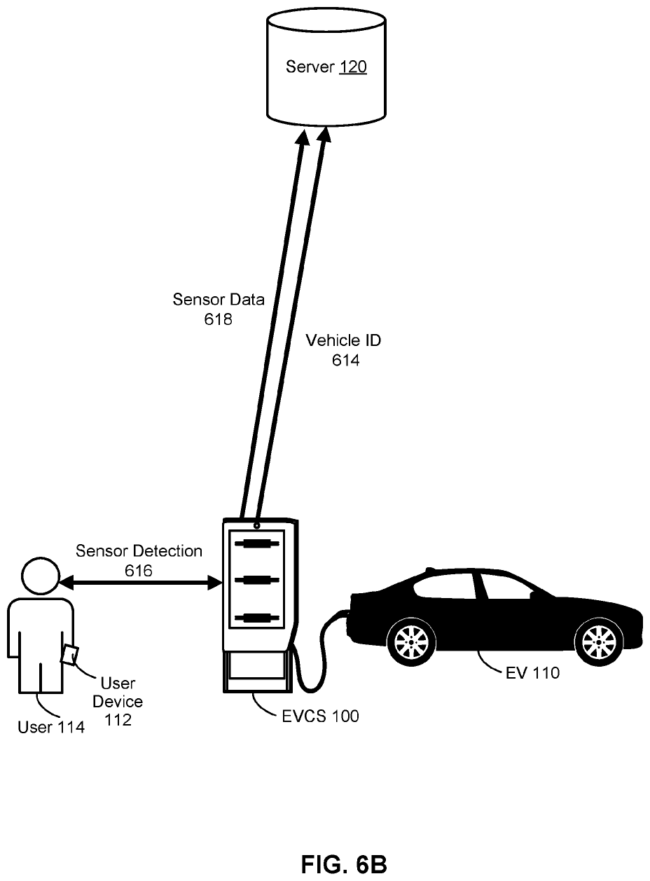

FIG. 6A is a block diagram illustrating an example scenario in which a beacon signal is used to seamlessly initiate charging at EVCS 100, in accordance with some implementations (FIG. 6A is not drawn to scale). Although the initiation of charging is used as an example, below, it should be understood that analogous embodiments may initiate other operations at an EVCS, such as increasing a length or amount of charging, or increasing a power supplied to the vehicle during charging. In some embodiments, analogous operations are performed to seamlessly check-in at an EVCS. In some embodiments, analogous operations may be used to check-out at the EVCS e.g., when a driver returns back to the EVCS before a battery has been fully charged or an expected charge time has completed, some embodiments automatically stop the charge without manual intervention.

As illustrated, user 114 may park their electric vehicle 110 in a bay of EVCS 100, where EVCS 100 is configured to provide an electric charge to electric vehicle 110 via one or more electrical connections. In some embodiments, in response to the user plugging electric vehicle 110 into the EVCS 100, information is exchanged between the electric vehicle 110 and the EVCS 100 that identifies the electric vehicle 110. For example, the information is exchanged via a CCS (e.g., or other cable) connection. In some embodiments, the information includes an identifier (e.g., a unique identifier) of the electric vehicle 110 (e.g., vehicle ID 604). In some embodiments, the identifier of the electric vehicle 110 may be spoofed by a bad actor such that a second vehicle appears, to EVCS, as electric vehicle 110 based on the identifier received via the CCS connection.

In some circumstances, in response to the electric vehicle 110 connecting to EVCS 100, a process for check-in is initiated (e.g., without user intervention, beyond plugging in the electric vehicle). In some embodiments, EVCS 100 transmits (e.g., forwards) the vehicle identifier (ID) 604 (e.g., as determined via the connection between the EVCS 100 and the electric vehicle 110) to the server 120. In some embodiments, alternative and/or additional ways of obtaining the vehicle ID are used. For example, in some embodiments, a camera 206 is enabled to determine a license plate, a color, a make, a model or other information about the electric vehicle to identify the electric vehicle 110. For example, in some embodiments the vehicle ID 604 is a license plate of the electric vehicle 110. In some embodiments, the vehicle ID is a CCS ID of the electric vehicle 110.

In some embodiments, EVCS 100 transmits a beacon signal 602 (e.g., a BLUETOOTH low energy (BLE) signal). For example, beacon signal 602 is continually transmitted by EVCS 100. In some embodiments, beacon signal 602 is transmitted by EVCS 100 in response to EVCS 100 detecting a vehicle parked in the vehicle bay (e.g., or a vehicle connecting to EVCS 100). In some embodiments, beacon signal 602 is capable of being detected by a mobile device within a threshold proximity of the EVCS 100 (e.g., beacon signal 602 is transmitted with a predetermined power such that it is detectable within a desired threshold proximity, such as 10 feet, 20 feet, etc.). In some embodiments beacon signal 602 includes an identifier of the EVCS 100. In some embodiments, beacon signal 602 includes information about a location of the EVCS 100. For example, the identifier of the EVCS 100 includes the location of the EVCS 100. In some embodiments, the identifier of the EVCS 100 is a unique identifier (e.g., without location information), such that server 120 recognizes the unique identifier as being associated with the EVCS 100.

In some embodiments, in accordance with the user device 112 being located within a predefined proximity of the EVCS 100, user device 112 detects the beacon signal 602 that is transmitted by EVCS 100. In some embodiments, one or more mobile applications running (e.g., in the background) on user device 112 are capable of recognizing (e.g., detecting) the beacon signal 602 (e.g., without user intervention). For example, in some embodiments, EVCS application 538 (e.g., and/or maps application 549) is enabled to recognize the beacon signal 602. In some embodiments, EVCS application 538 must be executing (e.g., running) on user device 112 in order to detect beacon signal 602. In some embodiments, the beacon signal 602, when received by user device 112, causes the user device 112 to perform one or more actions (e.g., such as forwarding the identifier of the EVCS 100, as described in more detail below).

In some embodiments, in response to user device 112 detecting beacon signal 602, the user device 112 transmits a first identifier 606 and/or a second identifier 608 to server 120. In some embodiments, the first identifier 606 comprises an identifier of the user of user device 112 (e.g., information about the user 114 of user device 112, such as user account information stored for EVCS application 538, e.g., a user name or email address used to login to a service associated with the EVCS). In some embodiments, the second identifier 608 comprises an identifier of the EVCS 100 (e.g., as determined from beacon signal 602). In some embodiments, beacon signal 602 includes instructions for the user device 112 to send the first identifier 606 and/or the second identifier 608 to the server 120. In some embodiments, the mobile application that recognizes (e.g., detects) the beacon signal 602 stores instructions for what actions to perform, by user device 112, in response to detecting the beacon signal.

In some embodiments, the server 120 receives (i) the vehicle ID 604 (e.g., from the EVCS 100, in response to EV 110 being plugged into EVCS 100) and (ii) the first identifier 606 and/or the second identifier 608 (e.g., from the user device 112). In some embodiments, the server 120 performs a lookup to determine whether the received vehicle ID 604 matches the user account information (e.g., indicated by first identifier 606). For example, the server 120 determines whether the user 114 is associated with the EV 110 (e.g., by determining whether vehicle ID 604 is associated with a user account (e.g., as stored in a database 338 of server 120)). In some embodiments, server 120 determines whether the first identifier 606 (e.g., user account information) matches the stored account information for the vehicle ID 604. As such, the server 120 determines whether the user device 112 is associated with the vehicle ID 604 (and thus EV 110).

In some embodiments, the server 120 determines from which EVCS (e.g., within a network of EVCSs) the vehicle ID 604 was received and determines whether the second identifier 608 (e.g., the EVCS identifier, as determined from the beacon signal 602, received at user device 112) matches the EVCS that transmitted the vehicle ID 604. As such, server 120 determines whether user device 112 is within proximity of the same EVCS that transmitted the vehicle ID (e.g., by comparing the second identifier 608 with the EVCS 100 that transmitted the vehicle ID). In some embodiments, the server 120 requires that both of the following criteria are met before initiating charging of the EV 110 by EVCS 100: (i) the first identifier 606 matches the account information associated with vehicle ID 604 and (ii) the second identifier 608 indicating the EVCS transmitting beacon signal 602 matches the EVCS 100 that sent the vehicle ID 604. In some embodiments, both criteria (i) and (ii) must be met within a threshold amount of time (e.g., the first and/or second identifier must be received within 2 minutes of receiving vehicle ID 604). In response to satisfying both criteria, the server 120 approves initiation of charging EV 110 by EVCS 100. For example, the server 120 sends an approval signal (e.g., an instruction to initiate charging) to EVCS 100 and/or to user device 112.

FIG. 6B is a block diagram illustrating an example scenario in which sensor data is used to seamlessly initiate charging at EVCS 100, in accordance with some implementations (FIG. 6B is not drawn to scale). Although the initiation of charging is used as an example, below, it should be understood that analogous embodiments may initiate other operations at an EVCS, such as increasing a length or amount of charging, or increasing a power supplied to the vehicle during charging. In some embodiments, analogous operations are performed to seamlessly check-in at an EVCS. In some embodiments, analogous operations may be used to check-out at the EVCS, e.g., when a driver returns back to the EVCS before a battery has been fully charged or an expected charge time has completed, some embodiments automatically stop the charge without manual intervention.

In some embodiments, the EVCS 100 is equipped with one or more sensors for detecting an individual within a predefined area of EVCS 100. For example, user 114 is detected (616) by the one or more sensors while the user 114 is within detectable range of the one or more sensors. For example, while the user is within a camera field of view, EVCS 100 collects data associated with user 114. In some embodiments, the one or more sensors only collect data within a predefined area relative to the EVCS 100. In some embodiments, EVCS 100 transmits sensor data 618 collected by the one or more additional sensors of the EVCS to server 120. Although the examples described below refer to sensors of the EVCS 100 collecting and transmitting data to server 120, it will be understood that in some embodiments, sensors of the user device 112 are used instead of, or in conjunction with, the sensors of the EVCS 100 to collect and transmit data (e.g., biometric data) to server 120.

In some embodiments, the data collected by the one or more additional sensors comprises biometric data. For example, the EVCS 100 (e.g., or a user device 112) collects microphone data corresponding to a voice input of the user (e.g., a voice print). In some embodiments, the EVCS collects other biometric data (e.g., in addition to or instead of the microphone data). For example, the EVCS collects a palm print, a finger print, and/or a retinal scan using one or more sensors (e.g., scanners) at the EVCS.

In some embodiments, the biometric data is collected (e.g., via sensor detection 616) without user intervention. For example, a camera of the EVCS 100 passively determines whether one or more features detected by the camera (e.g., facial features) of the individual match features of a user ID that is associated with the vehicle ID. In some embodiments, a fingerprint and/or palm sensor is placed on a portion of the EVCS that the user touches to initiate charging (e.g., sensors on a charge gun that the user touches when connecting the charger to the electric vehicle) (e.g., and thus the user 114 need not take any additional action to input their finger and/or palm print that is separate from plugging in the EV 110 for charging).

In some embodiments, the server system 120 compares the received sensor data 618 with the vehicle ID 614 (e.g., received from EVCS 100 upon EV 110 plugging into EVCS 100) to determine whether to initiate charging of EV 110. For example, the server 120 performs a lookup of vehicle ID 614, and determines one or more features of a user associated with vehicle ID 614 (e.g., one or more biometric features of the user). The server 120 determines whether sensor data 618 received from the EVCS 100 matches (e.g., by satisfying a threshold amount of similarity with) the one or more features of the user associated with the vehicle ID 614 (e.g., wherein the one or more features of the user are stored by server 120 during an initial set-up of the seamless check-in process). In some embodiments, by cross-referencing the collected biometric data with the EVCS data indicating the vehicle ID, the server 120 is enabled to verify whether the biometric data matches a user that is associated with the vehicle ID (e.g., thereby reducing false positives that may occur by only using the biometric data to determine the user). In some embodiments, a plurality of users are associated with a same electric vehicle, and the server 120 uses the received vehicle ID to determine whether any user of the subset of users (e.g., from a database of users) match the biometric data (e.g., biometric data is stored for a plurality of drivers associated with the electric vehicle).

In some embodiments, in accordance with a determination that first biometric data does not match any of the users associated with the received vehicle ID, the server 120 requests the EVCS 100 to transmit additional sensor data (e.g., or the additional sensor data is automatically sent to the server 120, and the server 120 tries to perform a match on the additional sensor data). For example, if facial features obtained from the camera of EVCS 100 do not match features stored for any of the users associated with the vehicle ID, the server 120 analyzes another type of feature (e.g., using the sensor data 618 received from EVCS 100) (e.g., a voice print of the user).

In some embodiments, the EVCS 100 prompts the user to perform one or more actions to obtain biometric data (e.g., if the automatically collected data does not match). For example, the EVCS 100 (e.g., in response to a request received from server 120), requests that the user confirm initiation of charge using the user device 112 (e.g., and user device 112 optionally includes a prompt for verification).

In some embodiments, the biometric data is received at server 120 instead of the first identifier 606 and/or second identifier 608 described with reference to FIG. 6A (e.g., user device 112 does not detect beacon signal 602). For example, instead of (e.g., or in addition to) EVCS 100 transmitting a beacon signal to be detected by user device 112, EVCS 100 (e.g., and/or user device 112) transmits biometric data to server 120 to authenticate an identity of a user associated with the vehicle ID.

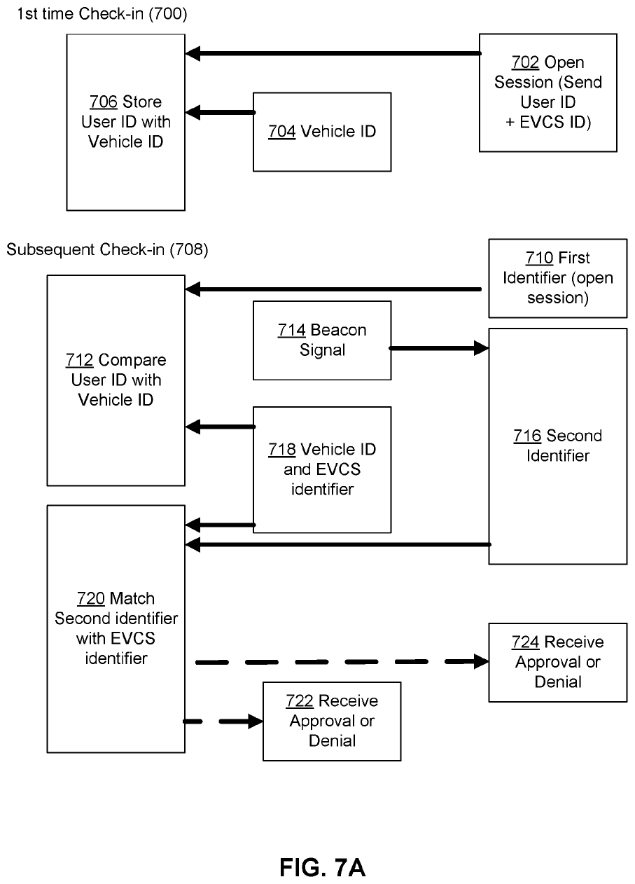

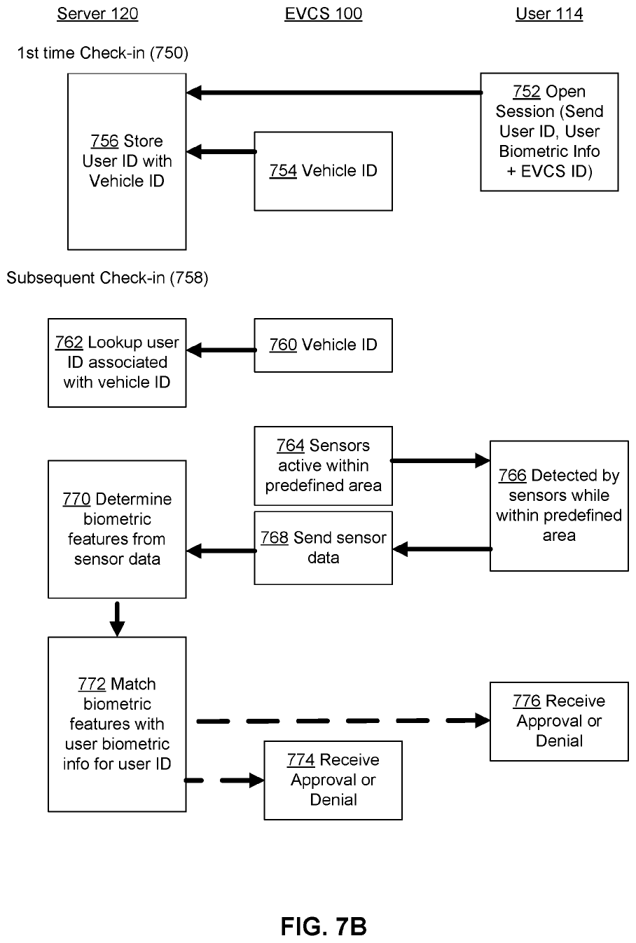

FIG. 7A illustrates a flowchart describing the seamless check-in process shown in FIG. 6A. In some embodiments, before the seamless check-in process in FIG. 6A can be implemented, a user must first associate the user's account with a respective vehicle ID (e.g., and agree to opt-in to the seamless charging process for future check-ins). For example, to initialize the seamless check-in process, during a first time check-in process 700, user 114 checks in manually (e.g., using user device 112). For example, user device 112 opens a session (702) with the EVCS application 538. In some embodiments, opening the session comprises creating or logging into a user account for the EVCS application 538. In some embodiments, the user 114 determines an identifier of EVCS 100 (e.g., a unique charging station identifier that is typically displayed on the charging station, e.g., in the form of a number or a QR-code). In some embodiments, the user device 112 sends the user account information (e.g., based on the login information) and sends the identifier of EVCS 100 to the server 120 (e.g., such that server 120 can determine which charging station the user is currently using). In some embodiments, in response to plugging the user's vehicle into EVCS 100, EVCS 100 receives vehicle identification information (e.g., vehicle ID, obtained via a cable connection) and transmits the vehicle ID (704) to the server 120. The server 120 recognizes from which EVCS 100 the vehicle identification information is received, and stores (706) the vehicle ID as being associated with the user account information. In other words, the server 120 matches the user account that checked-in to the EVCS with the vehicle ID that is plugged into the same EVCS and stores the user account information in association with the vehicle ID.

In some embodiments, before storing the user account information with the vehicle ID, the user is prompted (e.g., on user device 112) to enable seamless check-in for future charging. For example, a user must approve (e.g., opt-in) to having their user account stored in association with the vehicle ID by the server 120.

In some embodiments, in accordance with the user opting in to the seamless check-in functionality, during a subsequent check-in (708) (e.g., after the user has approved using seamless check-in), a user is enabled to initiate the charging process without requiring user input on the user device 112, or input on EVCS 100. Instead, check-in (e.g., identification of the user, the user's vehicle, and initiation of charging the user's vehicle) is performed automatically without user input.

For example, as described with reference to FIG. 6A, in some embodiments, the user device 112 is running an application that is enabled to detect beacon signals (e.g., beacon signal 602). In some embodiments, the user has initiated a user session by opening the application on user device 112. It will be understood that the user need not be actively logged in or currently engaging with the application on user device 112 (e.g., user device 112 can remain, for example, in the user's pocket, so long as the user device 112 is executing (in the background) an application that is enabled to recognize beacon signal 602 (e.g., EVCS application 538, or another mobile application)). In some embodiments, the first identifier (e.g., the user account identifier) is associated with the user of user device 112 (e.g., the first identifier comprises an identifier of the user, such as the user's log-in information for a service associated with the EVCS). In some embodiments, user device 112 sends (710) the first identifier to server 120 in accordance with the user opening a session with the mobile application. In some embodiments, the session must be opened within a predefined amount of time relative to the vehicle being plugged into the EVCS (e.g., such that the open session does not time out). It will be understood that in some embodiments, the first identifier is sent separately from the second identifier, as described above, when the first identifier is sent during the opening of a session of an application on the mobile device. In some embodiments, as described below, the first identifier is sent at the same time (e.g., concurrently with) the second identifier (e.g., wherein both the first identifier and the second identifier are transmitted to the server 120 in response to detecting the beacon signal 602).

In some embodiments, as described with reference to FIG. 6A, the EVCS 100 outputs beacon signal 602 (e.g., EVCS 100 continuously and/or regularly transmits beacon signal 602), which is capable of being detected by a mobile device (e.g., user device 112) within a predefined proximity of EVCS 100. In some embodiments, in accordance with user device 112 being located within the predefined proximity of EVCS 100, user device 112 detects (714) beacon signal 602 from EVCS 100. In some embodiments, in response to detecting beacon signal 602, user device 112 transmits (716) the second identifier to the server 120 (e.g., the second identifier including information about the EVCS 100). For example, beacon signal 602 includes the second identifier (e.g., the EVCS identifier) and the user device 112 forwards the second identifier to server system 120. In some embodiments, the user device 112 adds a user device identifier to the received beacon signal with the second identifier and forwards both the user device identifier (e.g., the first identifier) and the second identifier to server system 120 in a same message (e.g., together). In some embodiments, beacon signal 602 comprises a unique identifier and user device 112 generates the second identifier based on the beacon signal (e.g., the beacon signal is distinct from the second identifier generated by user device 112). In some embodiments, the generated second identifier includes the first identifier (e.g., the second identifier includes an identifier of the EVCS 100 and an identifier of the user of the user device 112).

In some embodiments, in response to the electric vehicle (e.g., EV 110) being plugged into EVCS 100, a vehicle identifier is determined by the EVCS 100 (e.g., the vehicle identifier received via a CCS or other cable or wireless connection between EV 110 and EVCS 100). In some embodiments, EVCS 100 forwards (718) the vehicle identifier and the EVCS identifier to the server 120. In some embodiments, the server 120 compares (712) the received first identifier with the received vehicle ID to determine whether the user of user device 112 is associated with the received vehicle ID. In some embodiments, server 120 compares the received first identifier with the received vehicle ID by performing a lookup in database 338 (e.g., where the user of user device 112 was stored in association with the vehicle ID during the first time check-in process 700, described above).

In some embodiments, the server 120 further uses the vehicle ID received from EVCS 100 to identify which EVCS 100 sent the vehicle ID (e.g., to determine the EVCS 100 in which the vehicle is currently plugged into). In some embodiments, server 720 determines (720) whether the EVCS 100 identifier (determined based on the vehicle ID received from the EVCS 100) matches the second identifier (e.g., generated based on the beacon signal received by the user device 112). Accordingly, server 120 determines whether the user's device is at the same EVCS as the EVCS where the vehicle ID is detected. Accordingly, server 120 requires a determination that (i) the received vehicle ID is associated with the received user account information and (ii) the user's device is within a predefined proximity of the EVCS that is plugged into the electric vehicle 110. In this way, a bad actor that spoofs a user's vehicle ID would not be able to seamlessly initiate charging (e.g., using stored payment information of user device 112) unless the user's device 112 is also within proximity of the EVCS and receives the beacon signal 602. This provides an additional layer of security such that users are more likely to use the seamless check-in feature.

FIG. 7B illustrates a flowchart describing the seamless check-in process shown in FIG. 6B. In some embodiments, before the seamless check-in process in FIG. 6B can be implemented, a user must first associate the user's account with a respective vehicle ID (e.g., and agree to opt-in to the seamless charging process for future check-ins, so as to obviate privacy concerns, e.g., from the use of biometric data, as described below). For example, to initialize the seamless check-in process, during a first time check-in process 750, user 114 checks in manually (e.g., using user device 112). For example, user device 112 opens a session (752) with the EVCS application 538. In some embodiments, opening the session comprises creating or logging into a user account for the EVCS application 538. In some embodiments, the user provides biometric information to be stored in association with the user account. For example, the user provides a facial scan (e.g., or a photograph) of the user, a fingerprint, a palmprint, and/or other biometric features to be stored in association with the user account. In some embodiments, the user 114 determines an identifier of EVCS 100 (e.g., a unique charging station identifier that is typically displayed on the charging station, e.g., in the form of a number or a QR-code, or received through wireless communication, such as a BLUETOOTH beacon or near-field communication). In some embodiments, the user device 112 sends the user account information (e.g., based on the login information) and sends the identifier of EVCS 100 to the server 120 (e.g., such that server 120 can determine which charging station the user is currently using). In some embodiments, in response to plugging the user's vehicle into EVCS 100, EVCS 100 receives vehicle identification information (e.g., vehicle ID, obtained via a cable connection) and transmits the vehicle ID (754) to the server 120. The server 120 recognizes from which EVCS 100 the vehicle identification information is received, and stores (756) the vehicle ID as being associated with the user account information (e.g., a user ID). In other words, the server 120 matches the user account that checked-in to the EVCS with the vehicle ID that is plugged into the same EVCS and stores the user account information in association with the vehicle ID.

In some embodiments, for a subsequent check-in (758) after the user has opted-in to seamless check-in (e.g., during a first time check-in process (750)), a vehicle ID (760) is transmitted from EVCS 100 to server 120. In some embodiments, as described above, the vehicle ID is obtained upon plugging the EV into EVCS 100 (e.g., via a CCS connection). In some embodiments, server 120, in response to receiving the vehicle ID, performs a lookup (762) of the vehicle ID to obtain one or more user IDs that are associated with the vehicle ID (e.g., as stored by server 120 during a first time check-in).

In some embodiments, the EVCS 100 includes one or more sensors that are active (764) and collect data within a predefined area relative to the EVCS 100. For example, the one or more sensors include a camera, a fingerprint sensor, and/or a microphone. In some embodiments, the predefined area is defined by the range of detection of the one or more sensors (e.g., the field of view of the camera, the distance from the microphone at which a voiceprint is detectable, etc.). In some embodiments, while user 114 is within the predefined area, the sensors detect (766) the user 114 and send the collected sensor data (768) to the server 120. In some embodiments, server 120 uses the sensor data to determine one or more biometric features (770) from the sensor data. In some embodiments, EVCS 100 determines the one or more biometric features from the sensor data and sends the features to server 120 (e.g., instead of sending the raw sensor data to server 120).

In some embodiments, the server 120 determines whether the biometric features from the sensor data match (772) biometric features that were stored with the user ID associated with the vehicle ID received at 762 (or any of the user IDs associated with the vehicle ID, e.g., in the case where multiple family members are associated with the vehicle ID). In some embodiments, in accordance with a determination that one or more biometric features detected at the EVCS 100 match one or more of the stored biometric features of the user associated with the received vehicle ID, the server 120 provides approval to initiate charging (e.g., to EVCS 100 (774) and/or to the device of the user 114 (776)).

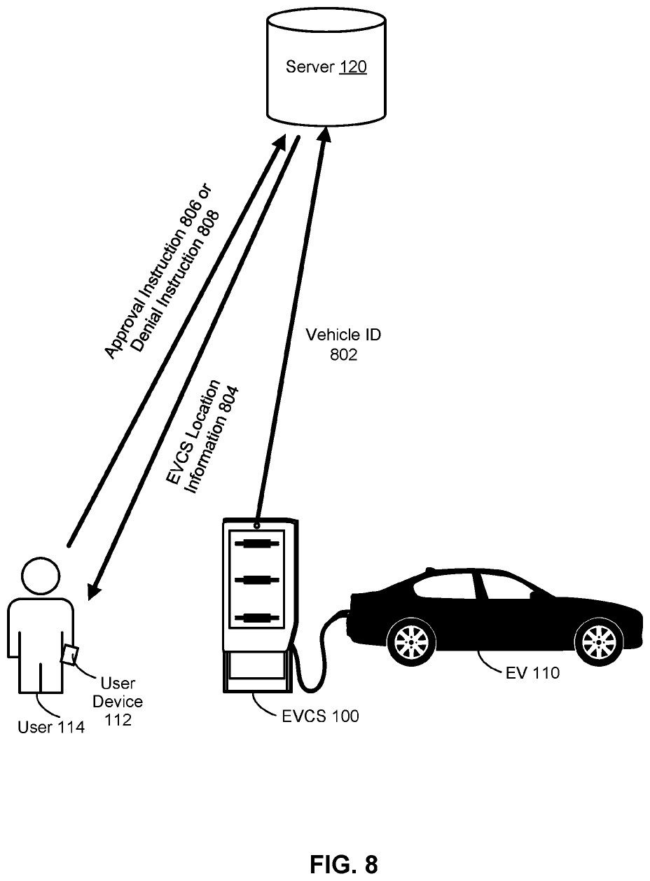

FIG. 8 illustrates an alternative system for implementing seamless check-in without a beacon signal. In some embodiments, in response to user 114 plugging in EV 110 to EVCS 100, a vehicle ID 802 is determined (e.g., via the cable connection, or by a camera determining a license plate) by EVCS 100 and transmitted to server 120, as illustrated in FIG. 8. In some embodiments, in response to server 120 receiving the vehicle ID 802, the server performs a lookup to identify a user that is associated with the vehicle ID. In some embodiments, the server 120 transmits a signal (e.g., message) to the user device of the identified user (e.g., user device 112). In some embodiments, the signal includes EVCS Location Information 804 (e.g., geographic coordinates, such as latitude/longitude coordinates, or other location-identifying information of the EVCS 100), which is determined for the EVCS that sent vehicle ID 802. In some embodiments, the signal further includes instructions for the user device 112 to compare a current location of the user device 112 with the EVCS Location Information 804.

In some embodiments, in response to receiving the signal from server 120 with the EVCS Location Information 804, user device 112 compares the EVCS Location Information 804 with a current location of user device 112 (e.g., using maps application 549, EVCS application 538, or another location-determining application). For example, user device 112 determines whether user device 112 is within a predefined proximity (e.g., 20 feet, 10 feet, etc.) of the EVCS that transmitted vehicle ID 802. In some embodiments, in accordance with a determination that user device 112 is within the predefined proximity, user device 112 sends an approval instruction 806 to the server 120, such that the server 120 may initiate charging at (or forward the approval instruction to) the EVCS 100 that sent the vehicle ID 802.

In accordance with a determination that user device 112 is not within the predefined proximity, user device 112 sends a denial instruction 808 denying (e.g., not approving) initiation of charging. In response to server 120 receiving an instruction 808 denying initiation of charging, the server 120 does not transmit a signal to EVCS 100 to initiate charging.

Accordingly, the seamless check-in process shown in FIG. 8 requires that user device 112 determines whether the user device 112 is within proximity of EVCS 100 before the server 120 provides EVCS 100 with permission to initiate charging of EV 110 (e.g., wherein the approval instruction 806 and/or permission to initiate charging of EV 110 includes permission to use stored payment information of the user account associated with user device 112).

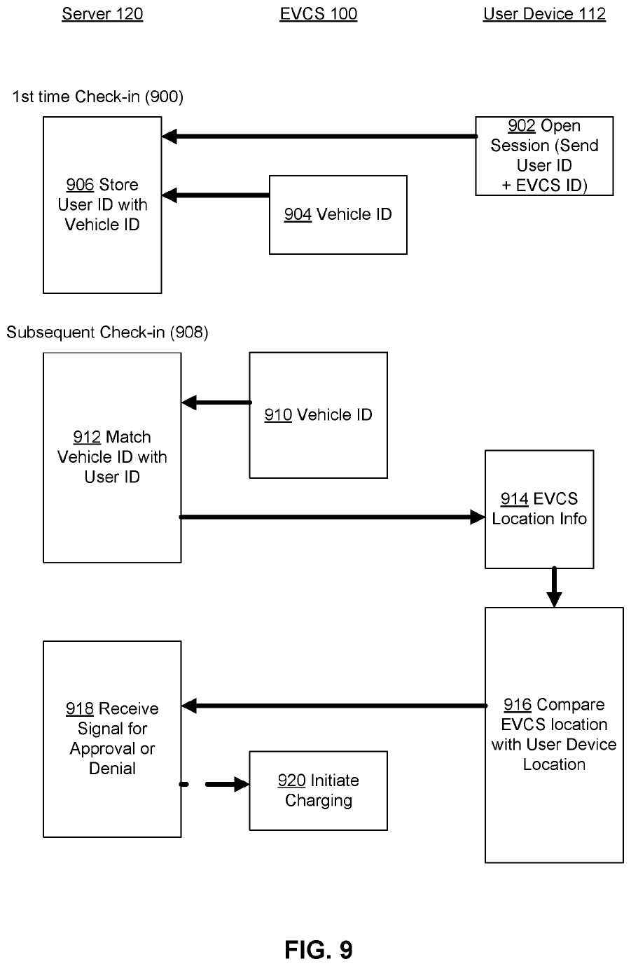

FIG. 9 illustrates a flowchart describing the seamless check-in process illustrated in FIG. 8. In some embodiments, the seamless check-in process of FIG. 9 begins with a first time check-in process 900. In some embodiments, the first time check-in process 900 is the same process 700 described with reference to FIG. 7A. For example, a user opens (902) a session by transmitting, to server 120, user account information (e.g., User ID) and an identifier of an EVCS (“EVCS ID”) (the EVCS in which the user is currently using to charge their vehicle). In some embodiments, the EVCS 100 sends the vehicle ID (904), as determined via a cable or wireless connection (e.g., CCS) to the server 120. Server 120 matches the vehicle ID that was transmitted from the EVCS to the user account information associated with user device 112 (which input the same EVCS ID). In other words, the server 120 receives EVCS ID with the User ID and performs a lookup of the EVCS ID to see what vehicle ID is currently (e.g., or becomes within a threshold amount of time) plugged into the identified EVCS. Server 120 stores (906) the user account information with the vehicle information based on the match.

After storing the user ID in association with the Vehicle ID during the first time check-in process 900, a subsequent check-in process 908 is performed. For example, during a subsequent check-in to a charging station (e.g., when the user returns to an EVCS to charge their vehicle), the EVCS 100 transmits the vehicle ID (910) to the server system. Server 120 thus recognizes that the respective vehicle has been plugged into the respective EVCS that transmitted the vehicle ID. In some embodiments, the EVCS 100 transmits an EVCS identifier with the vehicle ID. In some embodiments, the EVCS 100 need not transmit an EVCS identifier because server 120 is enabled to determine the origin of the signal that includes the Vehicle ID without an explicit EVCS identifier (e.g., server 120 can tell which EVCS in a network of EVCSs transmitted the respective Vehicle ID).

In some embodiments, in response to receiving the vehicle ID from the EVCS 100, server 120 performs a lookup to determine a user account associated with the vehicle ID received from the EVCS. The server 120 matches (912) the vehicle ID to a user account (e.g., and a user device associated with the account). The server 120 sends (914), to the user device associated with the matched user account, EVCS location information. For example, as described above, the server 120 determines which EVCS the vehicle was plugged into, and sends location information (e.g., geographic coordinates) for the respective EVCS to the user device 112 corresponding to the vehicle ID.

In some embodiments, user device 112 receives the EVCS location information from server 120 and determines a current location of user device 112. In some embodiments, user device 112 compares (916) the current location of user device 112 with the EVCS location information received from the server 120. In some embodiments, in accordance with a determination (e.g., using location determination module 540) that user device 112 is located within a predefined proximity to (e.g., distance from, or within a predefined area surrounding) the EVCS location information (e.g., geographic coordinates), the user device 112 transmits a signal of approval (e.g., confirming that user device 112 is near the EVCS 100) to server 120. In response to receiving (918) the signal of approval, the EVCS sends an instruction to EVCS 100 to initiate (920) charging at the EVCS. In some embodiments, in accordance with a determination, by the user device 112, that the user device 112 is not within a predefined proximity to the EVCS 100, user device 112 sends a signal denying access to the user account, and server 120 forgoes sending an instruction to the EVCS 100 to initiate charging. For example, if a bad actor has spoofed the vehicle ID, the user's device will determine that the vehicle ID is plugged into an EVCS 100 that is not near a current location of user device 112, and thus the server does not approve of initiating charge at EVCS 100 using the stored payment information for the user account associated with user device 112. Accordingly, the process 908 provides for dual-authentication before automatically initiating charging of the vehicle plugged into EVCS 100. In some embodiments, if the seamless check-in process results in denying access to the user account, the user is notified to check-in manually.

It will be understood that EVCS 100 as described herein is an example of one EVCS in a network of EVCSs. For example, a user is enabled to subsequently check in at various different EVCSs that are part of the same network of EVCSs (e.g., that communicate with server 120). For example, in some embodiments, when the respective EVCS transmits the vehicle ID that was plugged in to the server 120, the EVCS also transmits an identifier of the EVCS such that server 120 is enabled to determine which EVCS (e.g., within the network of EVCSs) has been plugged into the vehicle associated with the vehicle ID.

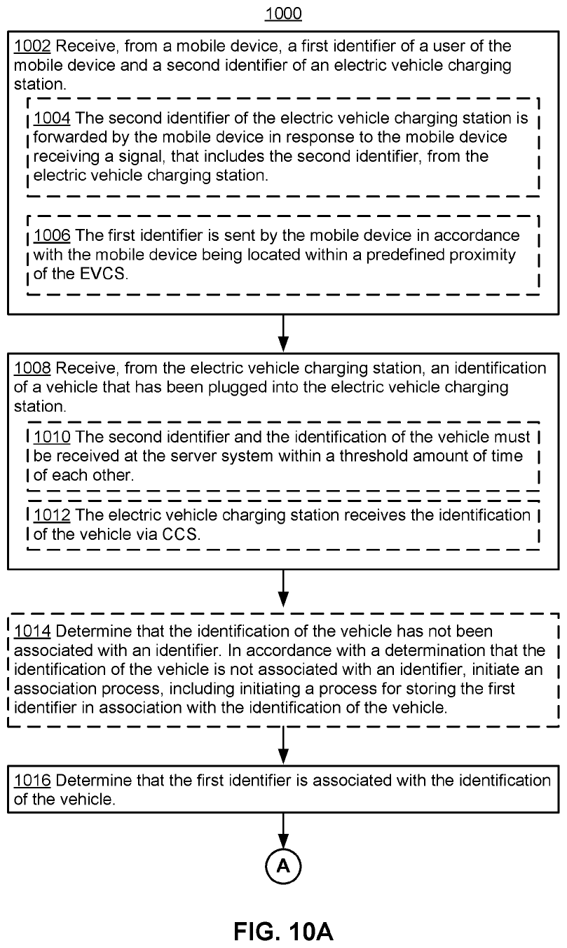

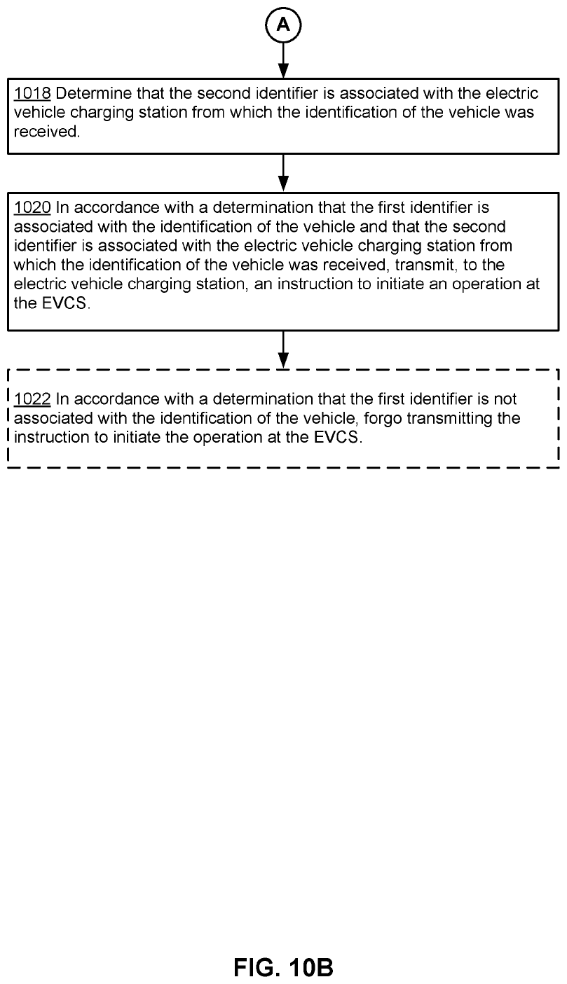

FIGS. 10A-10B illustrate a flowchart of a method 1000 of seamless check-in for a user at an EVCS. The method 1000 is performed at a server system with one or more processors and memory (e.g., server system 120, FIG. 2).

The method 1000 comprises receiving (1002), from a mobile device (e.g., user device 112), a first identifier of a user of the mobile device (e.g., an identifier of a user profile stored on the mobile device and/or account information) and a second identifier of an electric vehicle charging station. In some embodiments, the mobile device sends the second identifier without user intervention. For example, as explained above with reference to FIGS. 6-7, user device 112 sends the second identifier 608 in response to detecting beacon signal 602. In some embodiments, the first identifier of the mobile device (e.g., user device 112) is transmitted with the second identifier (e.g., in a same message to server 120). In some embodiments, the first identifier is transmitted to the server 120 before plugging in the vehicle to the EVCS (e.g., the first identifier is transmitted when the user opens a session with an application (e.g., EVCS application 538) at the mobile device).

In some embodiments, the second identifier of the electric vehicle charging station is forwarded (1004) by the mobile device in response to the mobile device receiving a signal, that includes the second identifier, from the electric vehicle charging station. In some embodiments, the signal comprises a BLE signal or other beacon signal transmitted by the EVCS. In some embodiments, the first identifier is also sent to the server system in response to receiving the signal. For example, as described with reference to FIG. 7A, in some embodiments, the first identifier is sent (710) with the second identifier (716) in response to receiving beacon signal at step 714.

In some embodiments, the first identifier is sent (1006) by the mobile device in accordance with the mobile device being located within a predefined proximity of the EVCS. For example, in some embodiments, a session is opened between the user device 112 and server 120 in response to the user device 112 being within a predefined proximity of the EVCS (e.g., based on EVCS application 538 detecting that the user device 112 is within the predefined proximity). For example, if the mobile device is not near the EVCS, no identifier (e.g., neither the first nor second identifier) is sent to the server system and therefore seamless check-in is not completed.

The method comprises receiving (1008), from the electric vehicle charging station, an identification of a vehicle that has been plugged into the electric vehicle charging station. For example the server system 120 receives the vehicle ID (e.g., sent at step 718, FIG. 7A) from EVCS 100.

In some embodiments, the second identifier and the identification of the vehicle must be received (1010) at the server system within a threshold amount of time of each other. For example, the server must receive both at around the same time (e.g., within 1 minute of each other). In some embodiments, the first identifier must also be received within the threshold amount of time. In some embodiments, the first identifier need not be received within the threshold amount of time. For example, the first identifier is received outside of the threshold amount of time (e.g., during an application initiation process before receiving the second identifier and the identification of the vehicle). In some embodiments, the first identifier must be received within a second threshold amount of time (e.g., a session timeout threshold) in accordance with a determination that the first identifier is received upon initiation of a session between device 112 and server 120.

In some embodiments, the electric vehicle charging station receives (1012) the identification of the vehicle via CCS. In some embodiments, the identification of the vehicle is the CCS ID. In some embodiments, the identification of the vehicle is based on a license plate detected by a camera.

In some embodiments, the method includes determining (1014) that the identification of the vehicle has not been associated with an identifier (e.g., with a first identifier corresponding to a user and/or user account) (e.g., the vehicle has not yet been registered by the server system for seamless check-in). In some embodiments, in accordance with a determination that the identification of the vehicle is not associated with an identifier, the method includes initiating an association process, including initiating a process (e.g., process 700 and/or 900, described with reference to FIGS. 7 and 9) for storing the first identifier in association with the identification of the vehicle. For example, the method includes sending an option to the mobile device for the user to agree to the terms of storing the identification of the vehicle in association with the first identifier. In some embodiments, the user of the mobile device needs to confirm association (e.g., agree to the terms) before the server stores the identification of the vehicle in association with the identifier.

The method comprises determining (1016) that the first identifier is associated with the identification of the vehicle (e.g., by performing a lookup). For example, as described with reference to FIG. 7A, the server 120 compares (712) the User ID (first identifier) with the vehicle ID received from the EVCS 100.

The method further comprises determining (1018) that the second identifier is associated with (e.g., matches) the electric vehicle charging station from which the identification of the vehicle was received. For example, as described with reference to step 720 in FIG. 7A, server 120 matches the second identifier (e.g., determined based on the beacon signal received by user device 112) with the EVCS that transmitted the vehicle ID (e.g., to determine whether a same EVCS (i) transmitted a beacon signal that was received by the user device and (ii) plugged into the vehicle with the vehicle ID).

The method further comprises, in accordance with a determination that the first identifier is associated with the identification of the vehicle and that the second identifier is associated with the electric vehicle charging station from which the identification of the vehicle was received, transmitting (1020), to the electric vehicle charging station, an instruction to initiate an operation at the EVCS, e.g., initiate charging of the vehicle, terminate charge of the vehicle, increase an amount or time for charging (e.g., free charging), increase a power supplied to the vehicle, etc. In some embodiments, the method further comprises approving a transaction for paying for the charging of the vehicle without additional user input (e.g., without the user entering payment or approval information), for example, by using stored payment information associated with the user account (e.g., indicated by the first identifier). In some embodiments, the method 1000 described herein provides additional security to seamless check-in because it is more difficult to “spoof” the system when the server is comparing two independent signals to see if they are associated with each other, namely, comparing a vehicle ID detected at a charging station with a mobile device ID that received a beacon from the charging station. Note that, if the mobile device is not within proximity to the charging station (e.g., and does not detect the beacon signal transmitted by the charging station), the seamless check-in process fails (e.g., and the user may check-in manually).

In some embodiments, in accordance with a determination that the first identifier is not associated with the identification of the vehicle, the method includes forgoing transmitting (1022) the instruction to initiate the operation at the EVCS. For example, if a second user's device transmits the first identifier (e.g., which is associated with the second user's account), but the first user's device does not transmit the first identifier (e.g., which is associated with the first user's account), the charge is not automatically initiated (e.g., and the second user will be required to initiate charging and enter payment information manually).

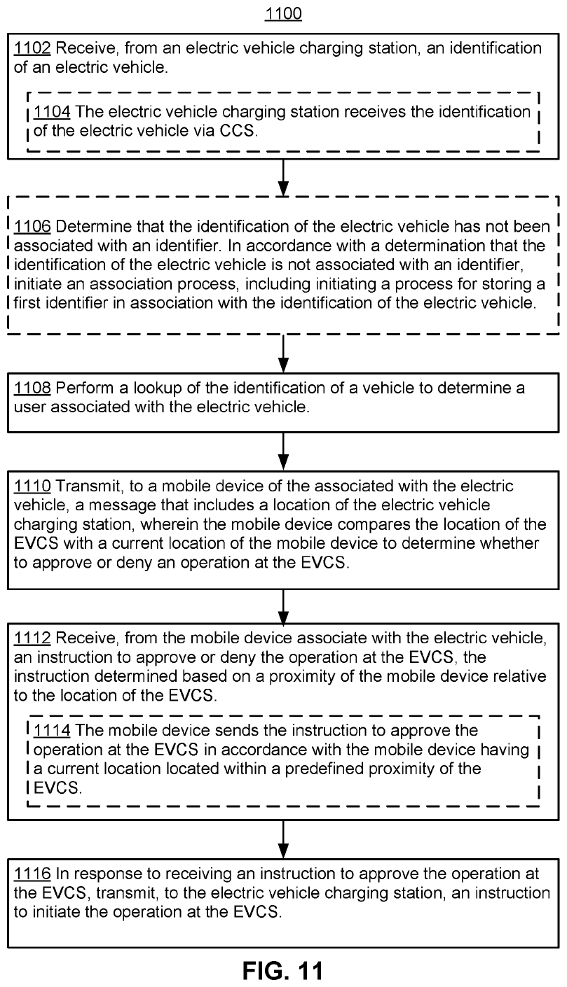

FIG. 11 illustrates a flowchart of a method 1100 of seamless check-in for a user at an EVCS. The method 1100 is performed at a server system with one or more processors and memory (e.g., server system 120, FIG. 2).

The method 1100 comprises receiving (1102), from an electric vehicle charging station, an identification of an electric vehicle. In some embodiments, the identification of a vehicle is determined by a license plate lookup (e.g., as detected by a camera of the EVCS). In some embodiments, the identification of the electric vehicle is determined upon the electric vehicle being plugged into the EVCS (e.g., via a cable or wireless connection).

In some embodiments, the electric vehicle charging station receives (1104) the identification of the electric vehicle via CCS. In some embodiments, the identification of the electric vehicle is the CCS ID.

In some embodiments, the method includes determining (1106) that the identification of the electric vehicle has not been associated with an identifier (e.g., with a mobile device corresponding to a user and/or user account) (e.g., the electric vehicle has not yet been registered by the server system for seamless check-in). In some embodiments, in accordance with a determination that the identification of the electric vehicle is not associated with an identifier, the method includes initiating an association process, including initiating a process (e.g., process 700 and/or 900, described with reference to FIGS. 7 and 9) for storing the first identifier in association with the identification of the electric vehicle. For example, the method includes sending an option to the mobile device (e.g., user device 112) for the user to agree to the terms of storing the identification of the electric vehicle in association with the first identifier. In some embodiments, the user of the mobile device needs to confirm association (e.g., agree to the terms) before the server stores the identification of the electric vehicle in association with the identifier.

The method comprises performing (1108) a lookup of the identification of a vehicle to determine a user associated with the electric vehicle. For example, as described with reference to FIGS. 8 and 9, in response to receiving vehicle ID 802, the server matches (912) the vehicle ID with a user ID.

The method further comprises transmitting (1110), to a mobile device of a user associated with the electric vehicle, a message that includes a location of the electric vehicle charging station (e.g., as described with reference to step 914 in FIG. 9). The mobile device compares the location of the EVCS with a current location of the mobile device to determine whether to approve or deny an operation at the EVCS (e.g., as described with reference to step 916 in FIG. 9). In some embodiments, the server system requests the location from the mobile device and does the comparison itself. In some embodiments, the determination that the first user is within the predefined proximity (e.g., predefined area) relative to the EVCS is based on a location of the mobile device, as determined by the mobile device (e.g., a GNSS location). In some embodiments, the mobile device is distinct from the electric vehicle.

The method further comprises receiving (1112), from the mobile device associated with the electric vehicle, an instruction to approve or deny the operation at the EVCS, the instruction determined based on a proximity of the mobile device relative to the location of the EVCS (e.g., as described with reference to step 918 in FIG. 9). In some embodiments, in accordance with the proximity being below a threshold proximity (e.g., within a threshold distance), the mobile device sends a signal of approval. In some embodiments, in accordance with the proximity being above a threshold proximity (e.g., outside of a threshold distance, as determined by a power level of the beacon signal received), the mobile device sends a signal denying the operation at the EVCS. In some embodiments, the instruction to approve or deny is generated without user input at the mobile device.

In some embodiments, the mobile device sends (1114) the instruction to approve the operation at the EVCS in accordance with the mobile device having a current location located within a predefined proximity of the EVCS. For example, if the mobile device is not near the EVCS, no approval is sent to the server system and therefore no charging is automatically initiated at the EVCS via the seamless check-in process.

The method further comprises, in response to receiving an instruction to approve the operation at the EVCS, transmitting (1116), to the electric vehicle charging station, an instruction to initiate the operation at the EVCS (e.g., as described with reference to step 920 in FIG. 9).

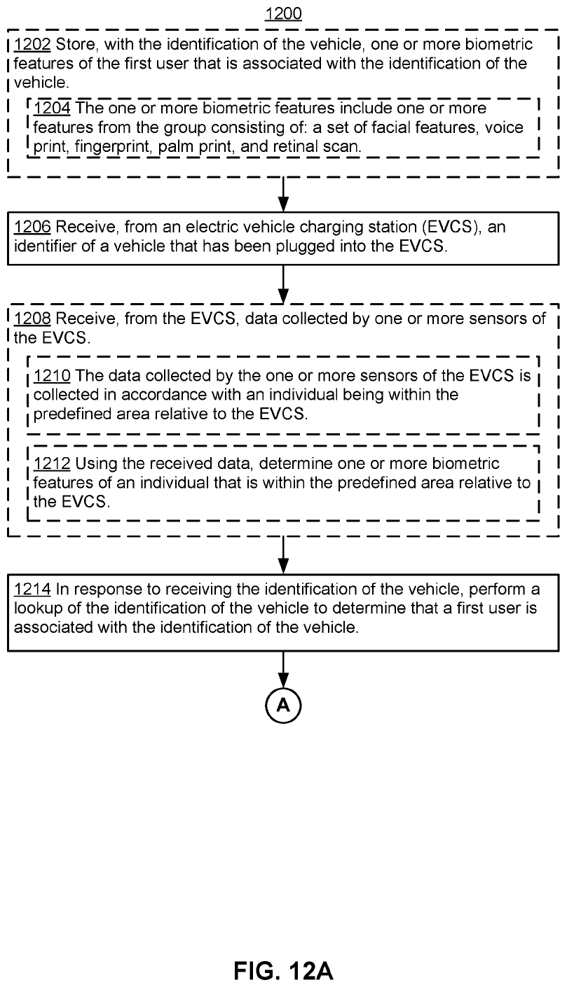

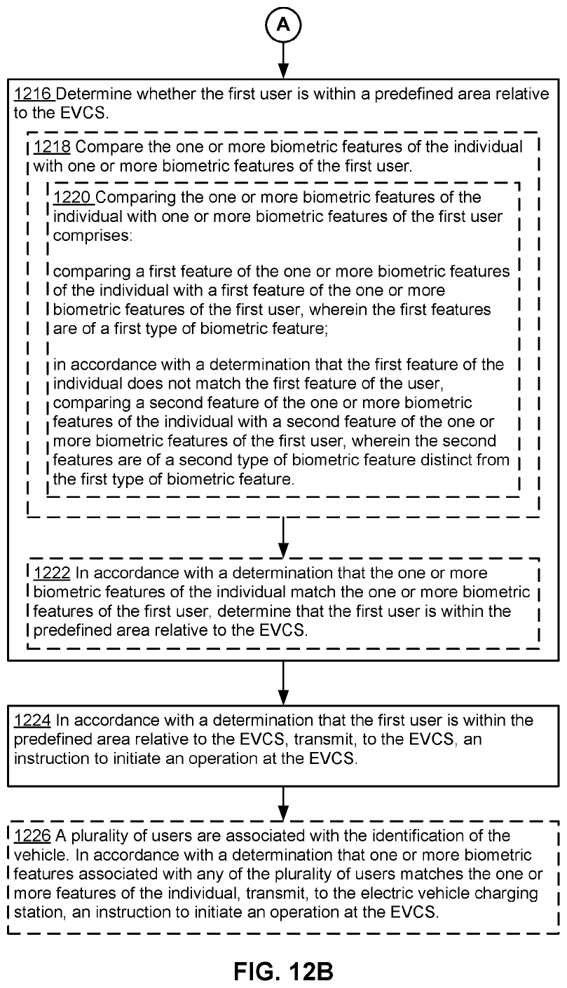

FIGS. 12A-12B illustrate a flowchart of a method 1200 of seamless check-in for a user at an EVCS. The method 1200 is performed at a server system with one or more processors and memory (e.g., server system 120, FIG. 2). In some embodiments, the method 1200 is performed in accordance with the steps described in FIGS. 6A-6B and 8. It will be understood that although the method 1200 is described with an example of using biometric features to determine that the first user is within the predefined area relative to the EVCS, alternative and/or additional methods may be used to make this determination (e.g., as described with reference to FIG. 6A and FIG. 8).

In some embodiments, the method includes storing (1202), with the identification of the vehicle, one or more biometric features of the first user that is associated with the identification of the vehicle. For example, the one or more biometric features are stored during first time check-in process 750 (FIG. 7B).

In some embodiments, the one or more biometric features include (1204) one or more features from the group consisting of: a set of facial features, voice print, fingerprint, palm print, and retinal scan.

The method includes, at the server system, receiving (1206), from an electric vehicle charging station, an identifier of a vehicle that has been plugged into the electric vehicle charging station (EVCS). Vehicle ID 604 (FIG. 6A), vehicle ID 614 (FIG. 6B), or vehicle ID 802 (FIG. 8) are examples of identifiers of a vehicle.

In some embodiments, the method includes receiving (1208), from the EVCS, data collected by one or more sensors of the EVCS (e.g., the sensor data sent at step 768, FIG. 7B).

In some embodiments, the data collected by the one or more sensors of the EVCS is collected (1210) in accordance with an individual being within a predefined area relative to the EVCS.

In some embodiments, the server system uses the received data to determine (1212) one or more biometric features of an individual that is within the predefined area relative to the EVCS (E.g., step 770, FIG. 7B).

The method includes, in response to receiving the identification of the vehicle, performing (1214) a lookup of the identification of the vehicle to determine that a first user is associated with the identification of the vehicle.

The method further includes determining (1216) whether the first user is within the predefined area relative to the EVCS (e.g., whether user 114 is within a predefined area of EVCS 100). In some embodiments, determining whether the first user is within the predefined area relative to the EVCS comprises performing operations described with respect to method 1000 (FIGS. 10A-10B) and/or method 1100 (FIG. 11). In such embodiments, the predefined proximity (described with reference to FIG. 10A-10B and 11) is the same as the predefined area. For example, in some embodiments, a server system matches a vehicle ID received at an EVCS to a EVCS identifier received by a mobile device (e.g., using a Bluetooth beacon), as described with reference to method 1000. The power on a Bluetooth beacon is calibrated to be received within the predefined area. In some embodiments, a GNSS location of the mobile device is compared to a known location of an EVCS, as described with reference to FIG. 11.

In some embodiments, the method includes using the biometrics features to determine that the first user is near the vehicle. In some embodiments, the server system compares (1218) the one or more biometric features of the individual with one or more biometric features of the first user (e.g., step 772, FIG. 7B).

In some embodiments, comparing the one or more biometric features of the individual with the one or more biometric features of the first user comprises (1220): comparing a first feature of the one or more biometric features of the individual with a first feature of the one or more biometric features of the first user, wherein the first features are of a first type of biometric feature, and, in accordance with a determination that the first feature of the individual does not match the first feature of the user, comparing a second feature of the one or more biometric features of the individual with a second feature of the one or more biometric features of the first user, wherein the second features are of a second type of biometric feature distinct from the first type of biometric feature.

In some embodiments, in accordance with a determination that the one or more biometric features of the individual match the one or more biometric features of the first user, the server system determines (1222) that the first user is within the predefined area relative to the EVCS.

The method further includes, in accordance with a determination that the first user is within the predefined area relative to the EVCS, transmitting (1224), to the EVCS, an instruction to initiate an operation at the EVCS. In some embodiments, the instruction to initiate an operation is an instruction to initiate an electric charge, assign a cost for the charge to the first user, and/or credit the first user's account with loyalty points.

In some embodiments, a plurality of users are associated (1226) with the identification of the vehicle, and the method further comprises, in accordance with a determination that one or more biometric features associated with any of the plurality of users matches the one or more features of the individual, transmitting, to the electric vehicle charging station, an instruction to initiate an operation at the EVCS.

It will be understood that, although the terms first, second, etc., are, in some instances, used herein to describe various elements, these elements should not be limited by these terms. These terms are only used to distinguish one element from another. For example, a first identifier could be termed a second identifier, and, similarly, a second identifier could be termed a first identifier, without departing from the scope of the various described implementations. The first identifier and the second identifier are both identifiers, but they are not the same identifiers unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method, comprising:
at a server system:
receiving, from an electric vehicle charging station, an identifier of a vehicle that has been plugged into the electric vehicle charging station (EVCS);
in response to receiving the identification of the vehicle, performing a lookup of the identification of the vehicle to determine that a first user is associated with the identification of the vehicle;
determining whether the first user is within a predefined area relative to the EVCS; and
in accordance with a determination that the first user is within the predefined area relative to the EVCS, transmitting, to the EVCS, an instruction to initiate an operation at the EVCS.

2. The method of claim 1, comprising:
receiving, from a mobile device, a first identifier of a user of the mobile device and a second identifier of an electric vehicle charging station;
determining that the first identifier is associated with the first user, including determining that the first identifier is associated with the identification of the vehicle by performing the lookup of the identification of the vehicle; and
determining that the second identifier is associated with the EVCS from which the identification of the vehicle was received, wherein
in accordance with a determination that the first identifier is associated with the identification of the vehicle and that the second identifier is associated with the electric vehicle charging station from which the identification of the vehicle was received, determining that the first user is within the predefined area relative to the EVCS.

3. The method of claim 2, wherein the second identifier of the electric vehicle charging station is forwarded by the mobile device in response to the mobile device receiving a signal, that includes the second identifier, from the electric vehicle charging station.

4. The method of claim 2, wherein the first identifier is sent by the mobile device in accordance with the mobile device being located within a predefined proximity of the electric vehicle charging station.

5. The method of claim 24, wherein the second identifier and the identification of vehicle must be received at the server system within a threshold amount of time of each other.

6. The method of claim 1, comprising:
storing, with the identification of the vehicle, one or more biometric features of the first user that is associated with the identification of the vehicle;
receiving, from the EVCS, data collected by one or more sensors of the EVCS;
using the received data, determining one or more biometric features of an individual that is within the predefined area relative to the EVCS; and
comparing the one or more biometric features of the individual with one or more biometric features of the first user, wherein
in accordance with a determination that the one or more biometric features of the individual match the one or more biometric features of the first user, determining that the first user is within the predefined area relative to the EVCS.

7. The method of claim 6, wherein the one or more biometric features include one or more features from the group consisting of: a set of facial features, voice print, fingerprint, palm print, and retinal scan.

8. The method of claim 6, wherein the data collected by the one or more sensors of the EVCS is collected in accordance with an individual being within the predefined area relative to the EVCS.

9. The method of claim 6, wherein comparing the one or more biometric features of the individual with the one or more biometric features of the first user comprises:
comparing a first feature of the one or more biometric features of the individual with a first feature of the one or more biometric features of the first user, wherein the first features are of a first type of biometric feature; and
in accordance with a determination that the first feature of the individual does not match the first feature of the user, comparing a second feature of the one or more biometric features of the individual with a second feature of the one or more biometric features of the first user, wherein the second features are of a second type of biometric feature distinct from the first type of biometric feature.

10. The method of claim 6, wherein:
a plurality of users are associated with the identification of the vehicle, and
the method further comprises, in accordance with a determination that one or more biometric features associated with any of the plurality of users matches the one or more features of the individual, transmitting, to the electric vehicle charging station, an instruction to initiate an operation at the EVCS.

11. The method of claim 1, wherein:
performing the lookup of the identification of the electric vehicle further comprises determining a mobile device associated with the electric vehicle; and
the method comprises:
transmitting, to the mobile device associated with the electric vehicle, a message that includes a location of the EVCS, wherein the mobile device compares the location of the EVCS with a current location of the mobile device to determine whether the mobile device is within the predefined area relative to the EVCS; and
receiving, from the mobile device associated with the electric vehicle, an indication that the mobile device is within the predefined area relative to the EVCS, wherein
in accordance with a determination that the mobile device is within the predefined area relative to the location of the EVCS, determining that the first user is within the predefined area relative to the EVCS.

12. The method of claim 1, further comprising, in accordance with a determination that the first user is not within a predefined area relative to the EVCS, forgoing transmitting the instruction to initiate the operation at the electric vehicle charging station.

13. The method of claim 1, wherein the electric vehicle charging station receives the identification of the vehicle via CCS.

14. The method of claim 1, further comprising, at the server system:
determining that the identification of the vehicle has not been associated with a user identifier; and
in accordance with a determination that the identification of the vehicle is not associated with a user identifier, initiating an association process, including initiating a process for storing the user identifier in association with the identification of the vehicle.

15. The method of claim 1, wherein the instruction to initiate an operation at the EVCS is an instruction to initiate charging of an electric vehicle at the EVCS.

16. A system, comprising:
one or more processors;
memory storing one or more programs, wherein the one or more programs are configured for execution by the one or more processors and include instructions for:
receiving, from an electric vehicle charging station, an identification of a vehicle that has been plugged into the electric vehicle charging station (EVCS);
in response to receiving the identification of the vehicle, performing a lookup of the identification of the vehicle to determine that a first user is associated with the identification of the vehicle;
determining whether the first user is within a predefined area relative to the EVCS; and
in accordance with a determination that the first user is within the predefined area relative to the EVCS, transmitting, to the EVCS, an instruction to initiate an operation at the EVCS.

17. (canceled)

18. A non-transitory computer readable storage medium storing instructions, which, when executed by a system that includes one or more processors, causes the one or more processors to perform a set of operations, comprising:
receiving, from an electric vehicle charging station, an identification of a vehicle that has been plugged into the electric vehicle charging station (EVCS);
in response to receiving the identification of the vehicle, performing a lookup of the identification of the vehicle to determine that a first user is associated with the identification of the vehicle;
determining whether the first user is within a predefined area relative to the EVCS; and
in accordance with a determination that the first user is within the predefined area relative to the EVCS, transmitting, to the EVCS, an instruction to initiate an operation at the EVCS.

19. (canceled)
